(19) United States
(12) Patent Application Publication
(10) Pub. No.: US 2025/0361913 A1
(43) Pub. Date: Nov. 27, 2025

(54) TRIPOD JOINT

(71) Applicant: GKN Driveline International GmbH, Lohmar (DE)

(72) Inventors: Orkan Eryilmaz, Lohmar (DE); Thomas Weckerling, Lohmar (DE); Hans-Jürgen Post, Lohmar (DE); Julian Lehnert, Lohmar (DE)

(21) Appl. No.: 18/872,081

(22) PCT Filed: Feb. 2, 2023
(86) PCT No.: PCT/EP2023/052549

§ 371 Date: Dec. 5, 2024

(51) Int. Cl. F16D 3/205

(52) U.S. Cl. CPC F16D 3/2055

(57) ABSTRACT

A tripod joint has an outer joint part having a first longitudinal axis, a cavity parallel to the first longitudinal axis and an open end. Three recesses extending parallel to the first longitudinal axis are formed in the outer joint part. An inner joint part has a second longitudinal axis, at least one central body on which three journals are formed, a roller body arranged on each of the journals and at least an outer ring and an inner ring which can be rotated relative to the latter about a common axis of rotation. When the axes are coaxial and a torque is transmitted during intended operation of the tripod joint between the journal and the inner ring via two contact points which, in a cross-section of the tripod joint running transversely to the longitudinal axes, are arranged spaced apart from one another along the radial direction.

### TECHNICAL FIELD

The present disclosure relates to a tripod joint with an outer joint part and an inner joint part with a central body that has three integrally formed journals. A roller body is arranged on each of the journals. The disclosure also relates to a motor vehicle with a tripod joint of this type.

### BACKGROUND

Tripod joints of this type regularly comprise an outer joint part having a first longitudinal axis and a cavity extending parallel to the first longitudinal axis and having an open end, three recesses extending parallel to the first longitudinal axis being formed in the outer joint part. The tripod joint also includes a joint inner part with a second longitudinal axis, comprising at least one central body on which three journals are formed with journal axes extending radially from the second longitudinal axis. A roller body is arranged on each journal, which has at least an outer ring and an inner ring that can be rotated relative to it (to the outer ring) about a common axis of rotation, as well as bearing bodies arranged between the outer ring and the inner ring. Each roller body is received in a recess in each case, movably along the first longitudinal axis.

To assemble the tripod joint, the inner joint part with the journals and the roller bodies arranged on them can be inserted via the open end into the cavity of the outer joint part.

The central body can itself form a shaft or be connected to a shaft, for example, by splines.

The inner part of the joint can be displaced along the first longitudinal axis relative to the outer part of the joint and can be deflected by a deflection angle relative to the outer part of the joint. The deflection angle is the smallest angle between the first and second longitudinal axis.

Tripod joints have been manufactured and sold by the applicant for some time, for example under the name AAR tripod joints. They are used in particular in motor vehicle side shafts, which serve as the drive connection between a differential gear and the drive wheels. In this case, so-called constant-velocity ball joints are usually used on the wheel side and the AAR tripod joints listed here are used as sliding joints on the side of the differential gear. The AAR tripod joints are designed in particular for deflection angles in the range of 23 to 26 angular degrees (or less).

In a subtype of the AAR tripod joint 1, the AARi tripod joint, the inner ring is cylindrical towards the journal and the inner ring is fixed to the outer ring by means of retaining rings in the direction along the axis of rotation.

The journal contacts the bearing bodies or the inner ring of the roller body via so-called sliding surfaces (contact surfaces), which are particularly designed in the shape of a spherical segment. These sliding surfaces are aligned in a circumferential direction around the second longitudinal axis, so that a torque acting around the longitudinal axes of the joint is transmitted via the sliding surfaces of the journal to the roller body and from the roller body to the recesses (or vice versa).

When a motor vehicle is in traction/pull mode, i.e. when the motor vehicle is driven by a drive unit, the journal contacts the roller body with one of the sliding surfaces and the roller body contacts, in particular, the one side of the recesses. When the motor vehicle is in push mode or sail mode (both referred to as coasting), i.e. when drive torques are introduced starting from the wheel and the drive unit is still connected (push mode) or decoupled (sail mode), the journal contacts the roller body with the other of the sliding surfaces and the roller body contacts, in particular, the other side of the recesses. In the case of push mode or sail mode, the direction of the applied torques and the direction of rotation of the joint are opposite to each other, whereas in the case of pull mode they are in the same direction.

A tripod joint is known from US 7 654 908 B2, in which the inner ring has a chamfer on a front side facing the central body of the inner part of the joint. This chamfer serves to enable the roller body to be mounted on the journal. Due to the reduced contact surface on the inner ring, unacceptably high edge loads can occur on the inner ring during the intended operation of the tripod joint, which can lead to a reduction in service life.

A tripod joint is known from JP 2002 286 046 A, which has local elevations on the inner ring that determine the position of the inner ring in relation to the journal.

In both joints, when the tripod joint is operated as intended, a torque acting in a circumferential direction is transmitted between the journal and the inner ring via one contact point in each case.

In particular, when the tripod joint is operated at an angle of deflection, this contact point can move along the axis of rotation and along the contour of the inner circumferential surface of the inner ring or along the contour of the outer circumferential surface of the journal.

If this contact point is located further out along a radial direction, a regular, smooth power transmission can occur because the contact point is still spaced from one end of the surface of the inner circumferential surface of the inner ring intended for contact with the journal.

However, if this contact point is further inward along the radial direction, the contact point may be located at one end of the inner ring inner circumferential surface provided for contact with the journal. This is particularly because the contour is shortened by the chamfer in this case. This may result in uneven force transmission and an increase in the edge load.

The object of at least some implementations of the present disclosure is to solve at least some of the problems described with regard to the state of the art. In particular, a tripod joint is to be proposed in which the edge loads on the inner ring are reduced during intended operation. The tripod joint should thus be designed to be more resilient and have a longer life expectancy.

### SUMMARY

These tasks are solved with a tripod joint. Further advantageous designs are indicated in the dependent claims. It should be noted that the features individually listed in the dependent claims can be combined with each other in any technologically meaningful way and define further embodiments of the disclosure. In addition, the features specified in the claims are further specified and explained in more detail in the description, with further embodiments of the disclosure being presented.

In the present case, the problems are solved by a tripod joint having
an outer joint part with a first longitudinal axis and a cavity running parallel to the first longitudinal axis and having an open end, three recesses running parallel to the first longitudinal axis being formed in the outer joint part, and
an inner joint part with a second longitudinal axis, comprising at least one central body, on which three journals are formed with journal axes extending outwards along a radial direction from the second longitudinal axis, wherein a roller body is arranged on each of the journals, which roller body has at least one outer ring and one inner ring rotatable with respect to the outer ring about a common axis of rotation, as well as bearing bodies arranged between the outer ring and the inner ring.

Each one of the roller bodies is accommodated in one of the recesses such that it can move along the first longitudinal axis. At least when the longitudinal axes are coaxial and when a torque acting in a circumferential direction is transmitted during intended operation of the tripod joint, a force can be transmitted between the journal and the inner ring constantly over (exactly) two contact points. In a cross-section of the tripod joint running transversely to the longitudinal axes, the contact points are arranged spaced apart from one another along the radial direction.

The roller body includes, in particular, the outer ring and the inner ring, which can rotate relative to each other. In addition, bearing bodies (rolling elements, e.g. needle-shaped rolling elements) are arranged in a known manner between the inner ring and the outer ring. These bearing bodies are arranged in a mounting space of the inner ring or the outer ring. A multiplicity of these bearing bodies are arranged along the circumferential direction around the axis of rotation.

The rotation of the inner ring in relation to the outer ring allows the roller body to roll along the recesses or raceways in the outer joint part, so that the inner joint part can be displaced along the first longitudinal axis in relation to the outer joint part.

When the inner part of the joint is deflected, the rolling elements continue to be guided by the raceways, with at least the journals being tilted with respect to the roller bodies.

In particular, the roller bodies may be guided by the recesses in such a way that it is not possible for the roller bodies to tilt with respect to the recesses.

Alternatively, when the inner part of the joint is deflected, the roller bodies are also tilted with respect to the recesses.

In addition to the relative rotation, the inner ring and the outer ring also perform a displacement along the common axis of rotation in relation to each other.

When the tripod joint is operated as intended, one of the inner ring and outer ring together with the bearing bodies can be displaced along the axis of rotation in relation to the other of the inner ring and outer ring.

The intended use of the tripod joint (also referred to as a joint) includes the inner and outer joint parts being arranged in relation to each other as intended for the specific application. For example, all roller bodies are arranged in the recesses and the joint is only operated in a certain range of the deflection angle, e.g. between zero and 30 angular degrees or between zero 0 and 26 angular degrees. Furthermore, the torques considered permissible for the joint are transmitted between the outer and inner joint parts and a displacement of the roller bodies along the first longitudinal axis occurs only to a certain extent.

Nonintended operation includes, for example, the assembly of the joint or the assembly of joint parts, e.g. the arrangement of the roller bodies on the journals.

In the present case, it is proposed that, at least in the case of coaxial arrangement of the longitudinal axes and when a torque acting in a circumferential direction is transmitted during intended operation of the tripod joint, a force between the journal and the inner ring (or between each journal and each inner ring) can be transmitted continuously via two contact points. These contact points are arranged at a distance from each other along the radial direction in a cross-section of the tripod joint running transversely to the longitudinal axes.

A first contact point is therefore arranged further out in the cross-section along the radial direction than a second contact point, which is arranged closer to the central body or closer to the second longitudinal axis.

When the force is transmitted via (exactly) two contact points, the force can be transmitted more evenly between the journal and the inner ring, in particular preventing tilting of the inner ring with respect to the axis of rotation or with respect to the bearing bodies and/or the outer ring. Likewise, an unacceptably high edge load is prevented in such a way that the service life of the joint can be improved.

In particular, the distance between the two contact points may be at least 2%, or at least 5%, or even at least 10%, of a smallest diameter of the inner ring. In particular, the distance may be at most 30%, or at most 20%, or at most 15%, of the smallest diameter of the inner ring.

The outer circumferential surface of the journal may be at least in the cross-section, at least in the area of the two contact points (therefore also between the two contact points), designed to be exclusively convexly curved. In particular, there may also be flat areas.

The inner circumferential surface of the inner ring may be at least in the cross-section, at least in the area of the two contact points (therefore also between the two contact points), designed to be exclusively concave. In particular, there may also be flat areas.

In particular, even if the longitudinal axes are not coaxial and a torque acting in a circumferential direction is transmitted during intended operation of the tripod joint, a force between the journal and the inner ring (or between each journal and each inner ring) can be transmitted continuously via two contact points.

In particular, with a change in the deflection and depending on the angle of rotation of the tripod joint, the contact points move along the inner circumferential surface of the inner ring and along the outer circumferential surface of the journal, respectively. The contact points are thus not arranged at a fixed point in the cross-section, but rather move along the radial direction (in the cross-section under consideration) depending on the deflection angle and the angle of rotation.

The angle of rotation is, in particular, the position of the respective journal along the circumferential direction during a rotation of the tripod joint through 360 angular degrees. During a rotation of the tripod joint, which is deflected by a deflection angle greater than zero angular degrees, the journal moves with the roller body along the first longitudinal axis in the recesses.

In particular, at no time during the intended operation of the tripod joint does the force between the journal and the inner ring pass through only one contact point.

In particular, at least when the longitudinal axes are arranged coaxially, the two contact points are each arranged at an equal distance from a PCR1 of the joint inner part along the radial direction.

The PCR1 is, in particular, the pitch circle radius of the joint inner part, referred to here as the first pitch circle radius (PCR1).

The pitch circle radius of the journals or the joint inner part is the so-called effective radius. This is defined for an extended joint, i.e. the longitudinal axes are arranged coaxially to one another. The effective radius defines the lever arm of the resultant force when torque is transmitted. The pitch circle radius of the journals or the inner part of the joint is therefore the radius, starting from the second longitudinal axis of the inner part of the joint, on which, for example, the center points of the spherical segment-shaped sliding surfaces of the journals are arranged when the joint is extended.

The definition of the pitch circle radius (also referred to as PCR) is generally known, in particular for tripod joints.

In particular, at least in the coaxial arrangement of the longitudinal axes, the two contact points are arranged at a different distance from a PCR1 of the joint inner part along the radial direction.

In particular, the first contact point, which may be arranged further outwards, is arranged at a greater distance from the PCR 1 than the second contact point.

In particular, in the cross-section, a contour of an outer circumferential surface of the journal may be designed to be spherical (which may be convexly spherical) at least between the contact points (or in the area of the contact points).

In particular, in the cross-section, a contour of an inner circumferential surface of the inner ring may be formed in a Gothic, elliptical or at least linear manner (which may be by several straight lines), at least between the contact points (or in the area of the contact points).

In particular, in the cross-section, a contour of a surface of the recess that can be contacted by the outer ring in an intended operation of the tripod joint may be formed spherically.

In particular, in the cross-section, a contour of a surface of the outer ring contacting the surface of the recess may be spherical, toroidal, barrel-shaped, straight, saddle-shaped, bi-toroidal, or otherwise.

In particular, in the cross-section, the contour of the surface of the recess that can be contacted by the outer ring when the tripod joint is operated as intended may be designed to guide the outer ring described above.

For example, if the outer ring of the roller body has a spherical outer contour on its outer circumferential surface, the outer ring can be tiltable about the center axis of the recess of the outer joint part or tiltable in the circumferential direction of the central body. The recess in the outer joint part is shaped accordingly so that the roller body is not fixed in the circumferential direction of the outer joint part, but can be tilted to both sides with respect to the center line of the recess in an orbital movement which may be in a range of zero to 5 angular degrees, or zero to 3 angular degrees. This tilting is referred to as the orbital movement or orbital angle. The center line of the raceway is the axis of each recess in the outer joint part, along which the roller bodies can move in the outer joint part as a result of the axial forces.

In this case, the angle compensation of the orbital movement can also take place at least partially between the journal and the inner ring. To do this, the outer circumferential surface of the journal must be convexly curved.

The convex shape of the outer circumferential surface of the journal means in particular that the outer circumferential surface is at least partially designed according to a spherical segment, a barrel segment, a toroidal segment or a cylindrical segment.

In particular, at least in the coaxial arrangement of the longitudinal axes, a PCR1 of the joint inner part and a PCR2 of the joint outer part may be of equal size.

Alternatively, at least in the coaxial arrangement of the longitudinal axes, a PCR1 of the joint inner part is larger or smaller than a PCR2 of the joint outer part.

To achieve particularly favorable guidance properties, an offset can be provided between the first pitch circle radii (PCR1) of the outer circumferential surfaces of the journals (i.e. the inner part of the joint) and the second pitch circle radii (PCR2) of the recesses (i.e. the outer part of the joint).

The pitch circle radius of the outer part of the joint or of the recesses is also the so-called effective radius, which is defined for an extended joint, i.e. the longitudinal axes are arranged coaxially to one another. The effective radius defines the lever arm of the resultant force when a torque is transmitted.

The offset of the pitch circle radii is therefore the difference between these pitch circle radii (PCR1-PCR2).

In particular, one of the inner ring and outer ring together with the bearing bodies can be displaced along the axis of rotation relative to the other of the inner ring and outer ring.

In particular, a mounting space for the bearing bodies on the outer ring or on the inner ring may be limited by at least one retaining ring arranged on the respective ring. In particular, the mounting space on both sides of the bearing bodies may be limited by a retaining ring in each case.

Furthermore, a motor vehicle with at least one tripod joint is also claimed here.

The use of indefinite articles (“a”, “an”), in particular in the claims and the description that reproduces them, is to be understood as such and not as a number word. Accordingly, terms or components introduced with it are to be understood in such a way that they are present at least once and, in particular, can also be present several times.

As a precaution, it should be noted that the number words used here (“first”, “second”, . . . ) primarily serve to distinguish between several similar objects, sizes or processes, and in particular do not necessarily imply any dependency and/or order of these objects, sizes or processes in relation to one another. If a dependency and/or sequence is required, this is explicitly stated here or it is obvious to a person skilled in the art when studying the specifically described design. Insofar as a component can occur multiple times (“at least one”), the description of one of these components can apply equally to all or some of the majority of these components, but this is not mandatory.

### BRIEF DESCRIPTION OF THE DRAWINGS

The disclosure and the technical environment will be explained in more detail below using the attached figures. It should be noted that the disclosure is not to be limited by the cited examples. In particular, it should be noted that the figures and in particular the illustrated proportions are only schematic. The following figures show:

FIG. 1 a known deflected tripod joint in a view along the first longitudinal axis, partly in section;

FIG. 2 a detail of the tripod joint according to FIG. 1, in an extended arrangement and in a view along the longitudinal axes in a section;

FIG. 3 a further representation of the detail according to FIG. 2 in a view along the longitudinal axes;

FIG. 4 the detail of FIG. 3 in a first deflected position of the tripod joint;

FIG. 5 the detail of FIG. 3 in a second deflected position of the tripod joint;

FIG. 6 a detail of a tripod joint, in a view along the longitudinal axes in section;

FIG. 7 the detail according to FIG. 6 for a first design variant of a tripod joint;

FIG. 8 the detail according to FIG. 6 for a second design variant of a tripod joint;

FIG. 9 the detail according to FIG. 6 for a third design variant of a tripod joint;

FIG. 10 the detail according to FIG. 6 for a fourth design variant of a tripod joint;

FIG. 11 the detail according to FIG. 6 for a fifth design variant of a tripod joint;

FIG. 12 the detail according to FIG. 6 for a sixth design variant of a tripod joint; and

FIG. 13 the detail according to FIG. 6 for a seventh design variant of a tripod joint.

### DETAILED DESCRIPTION

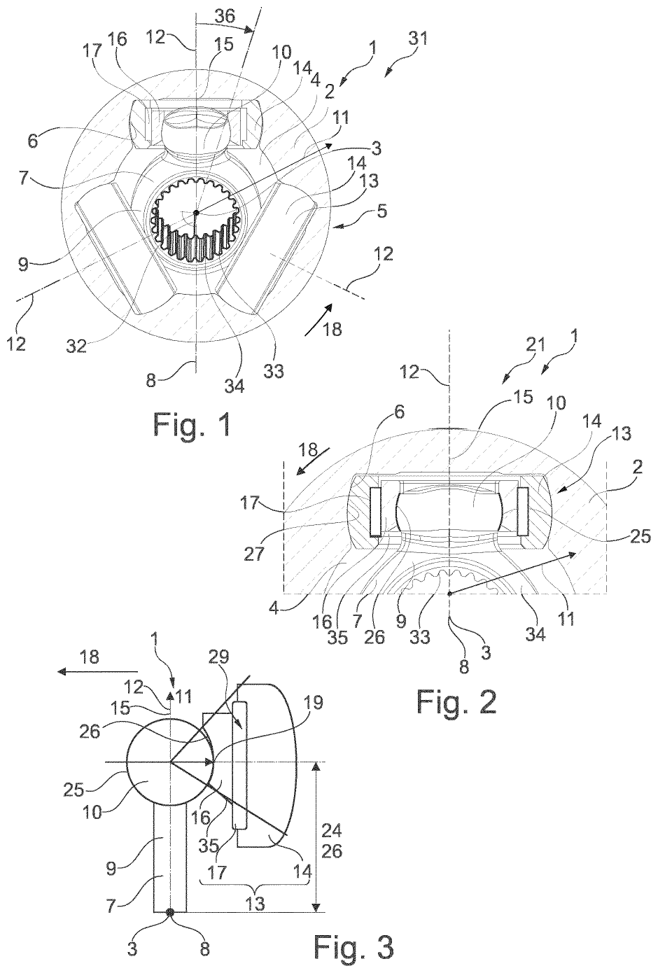

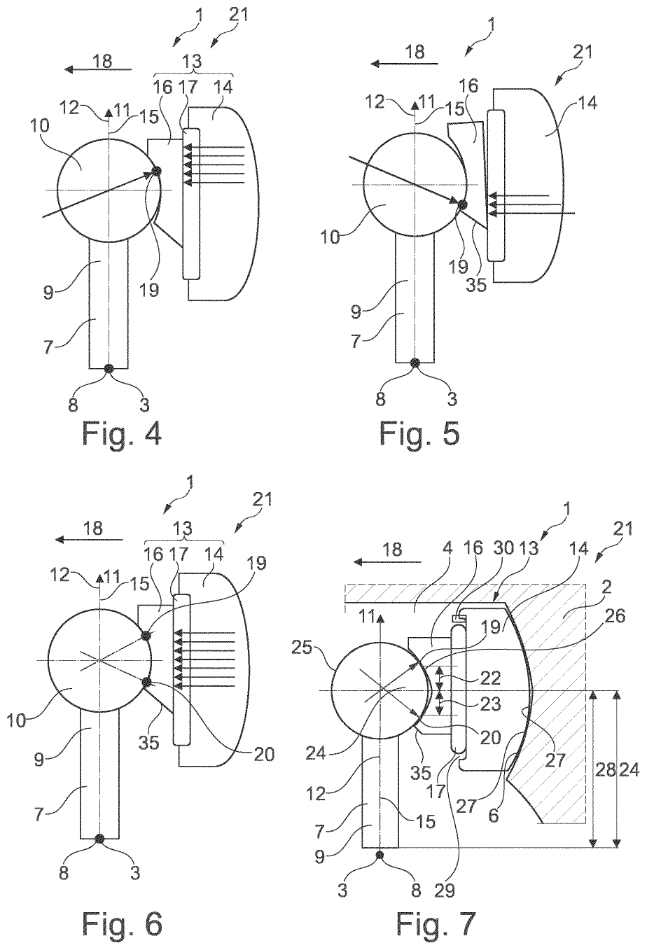

FIG. 1 shows a known, deflected tripod joint 1 in a view along the first longitudinal axis 3, partly in section. FIG. 2 shows a detail of the tripod joint 1 according to FIG. 1, in an extended arrangement and in a view along the longitudinal axes 3, 8 in section. FIG. 3 shows a further representation of the detail according to FIG. 2 in a view along the longitudinal axes 3, 8. FIG. 4 shows the detail of FIG. 3 in a first deflected position of the tripod joint 1. FIG. 5 shows the detail of FIG. 3 in a second deflected position of the tripod joint 1. The FIGS. 1 to 5 are described together in the following.

The tripod joint 1 comprises an outer joint part 2 having a first longitudinal axis 3 and a cavity 4 extending parallel to the first longitudinal axis 3 and having an open end 5, three recesses 6 extending parallel to the first longitudinal axis 3 being formed in the outer joint part 2. The tripod joint 1 also includes a joint inner part 7 with a second longitudinal axis 8. The joint inner part 7 includes a central body 9, on which three journals 10 are formed with a journal axis 12 extending outwards along a radial direction 11 from the second longitudinal axis 8. Each journal 10 has arranged on it a roller body 13 which has at least one outer ring 14 and one inner ring 16 which can be rotated in relation to the outer ring 14 about a common axis of rotation 15, as well as bearing bodies 17 (rolling elements, here needle-shaped rolling elements) arranged between the outer ring 14 and the inner ring 16. These bearing bodies 17 are arranged in a mounting/installation space 29 of the outer ring 14. The installation space 29 can also be formed by retaining rings 30 (see FIG. 7), in which case the bearing bodies 17 are secured by means of these retaining rings 30 and the outer ring 16 otherwise has, for example, a cylindrical surface. A plurality of these bearing bodies 17 are arranged along a circumferential direction around the axis of rotation 15.

Each roller body 13 is accommodated in each of the recesses 6 and is movable along the first longitudinal axis 3. At least when the longitudinal axes 3, 8 are arranged coaxially and when a torque acting in a circumferential direction 18 is transmitted, a force (see arrows in FIGS. 3, 4 and 5) can be transmitted continuously between the journal 10 and the inner ring 16 via exactly one contact point 19 during intended operation of the tripod joint.

The rotation of the inner ring 16 with respect to the outer ring 14 allows the roller body 13 to roll along the recesses 6 or raceways in the joint outer part 2, so that the joint inner part 7 can be displaced along the first longitudinal axis 3 with respect to the joint outer part 2.

When the inner part of the joint 7 is deflected, the roller bodies 13 continue to be guided by the recesses 6, with at least the journals 10 being tilted with respect to the roller bodies 13.

When the inner part of the joint 7 is deflected, the roller bodies 13 can also be tilted to a small extent with respect to the recesses 6.

In addition to the relative rotation, the inner ring 16 and the outer ring 14 also perform a displacement along the common axis of rotation 15 in relation to each other.

The intended use of the tripod joint 1 includes the inner joint part 7 and the outer joint part 2 being arranged in relation to each other as intended for the specific application. For example, all roller bodies 13 are arranged in the recesses 6 and the joint 1 is only operated in a certain range of the deflection angle 32 (indicated in FIG. 1), for example between zero and 30 angular degrees or between zero and 26 angular degrees. Furthermore, the permissible torques for joint 1 are transmitted between the outer joint part 2 and the inner joint part 7 and a displacement of the roller bodies 13 along the first longitudinal axis 3 only occurs to a certain extent.

Nonintended operation includes, for example, the assembly of the joint 1 or the assembly of joint parts, e.g. the arrangement of the roller bodies 13 on the journals 10.

The inner joint part 7 has a spline 33 on the central body 9 for connection to a shaft 34. The tripod joint 1 can be used in a motor vehicle 31 (here only indicated), e.g. to connect the shafts 34 between a differential gear and the drive wheels, in particular in side shafts of a motor vehicle 31, which serve, for example, to connect the drive (i.e. the connection of the wheels to a drive unit).

In FIGS. 2 to 5, it can be seen that the inner ring 16 has a chamfer 35 on an end face facing the central body 9 of the inner joint part 7. This chamfer 35 serves to enable the roller body 13 to be mounted on the journal 10. Due to the contact surface on the inner ring 16 being shortened by the chamfer 35, unacceptably high edge loads can occur on the inner ring 16 during the intended operation of the tripod joint 1, which can lead to a shorter service life.

In particular, when the tripod joint 1 is operated at a deflection angle 32, this contact point 19 can move along the axis of rotation 15 and along the contour of the inner circumferential surface 26 of the inner ring 16 or along the contour of the outer circumferential surface 25 of the journal 10.

If this contact point 19 is further outward along a radial direction 11, a regular and smooth power transmission can be realized because the contact point 19 is still spaced apart from an end of the surface of the inner circumferential surface 26 of the inner ring 16 that is intended to contact the journal 10 (see FIG. 4).

However, if this contact point 19 is located further inward along the radial direction 11, the contact point 19 may be located at one end of the surface of the inner circumferential surface 26 of the inner ring 16 that is intended to contact the journal 10. This is because the contour is shortened by the chamfer 35 in this case. This may result in uneven power transmission and an increase in the edge load.

For example, if the only point of contact 19 between the outer circumferential surface 25 of the journal 10 and the inner circumferential surface 26 of the inner ring 16 is displaced in the radial direction 11 far inward toward the central body 9 (see FIG. 5), the inner ring 16 may tilt with respect to the outer ring 14, thereby exacerbating the problem of unacceptably high edge load.

The rotation angle 36 is the position of the respective journal 10 along the circumferential direction 18 when the tripod joint 1 rotates 360 angular degrees. When the tripod joint 1, which is deflected by a deflection angle 32 greater than zero angular degrees, rotates, the journal 10 moves with the roller body 13 along the first longitudinal axis 3 in the recesses 6. Here, the journal 10 arranged at the top is at a rotation angle 36 of zero angular degrees, the next journal 10 in the clockwise direction (bottom right) is arranged at a rotation angle 36 of 120 angular degrees, and the journal 10 arranged at the bottom left is arranged at a rotation angle 36 of 240 angular degrees.

FIG. 6 shows a detail of a tripod joint 1, in a view along the longitudinal axes 3, 8 in section. FIG. 7 shows the detail according to FIG. 6 for a first design variant of a tripod joint 1. FIGS. 6 and 7 will be described together in the following. Reference is made to the explanations for FIGS. 1 to 5.

At least in the case of a coaxial arrangement of the longitudinal axes 3, 8 and when a torque acting in a circumferential direction 18 is transmitted during intended operation of the tripod joint 1, a force (arrows in FIG. 6) can be transmitted continuously between the journal 10 and the inner ring 16 via exactly two contact points 19, 20. The contact points 19, 20 are arranged at a distance from one another along the radial direction 11 in a cross-section 21 of the tripod joint 1 running transversely to the longitudinal axes 3, 8.

The roller body 13 comprises the outer ring 14 and the inner ring 16, which can rotate relative to one another. For this purpose, bearing bodies (rolling elements, e.g. needle-shaped rolling elements) are arranged in a known manner between the inner ring 16 and the outer ring 14. These bearing bodies 17 are arranged in a mounting space 29 of the outer ring 14. A multiplicity of these bearing bodies 17 are arranged along the circumferential direction around the axis of rotation 15.

When the tripod joint 1 is operated as intended, the inner ring 16 can be displaced along the axis of rotation 15 with respect to the outer ring 14 and the bearing bodies 17.

In cross-section 21, a first contact point 19 is arranged further out along the radial direction 11 than a second contact point 20, which is arranged closer to the central body 9 or closer to the second longitudinal axis 8.

When the force is transmitted via exactly two contact points 19, 20, the force can be transmitted more evenly distributed between the journal 10 and the inner ring 16, in particular preventing tilting of the inner ring 16 with respect to the axis of rotation 14 or with respect to the bearing bodies 17 and the outer ring 14. Likewise, an impermissibly high edge load is prevented, so that the service life of the joint 1 can be improved.

The distance between the two contact points 19, 20 is approximately 10% of a smallest diameter of the inner ring 16.

The outer circumferential surface 25 of the journal 10 is, at least in the cross-section 21, at least in the region of the two contact points 19, 20 (and thus also between the two contact points 19, 20), designed to be exclusively convexly curved.

The inner circumferential surface 26 of the inner ring 16 is, at least in the cross-section 21, at least in the region of the two contact points 19, 20 (thus also between the two contact points 19, 20), exclusively of concave curvature.

Even if the longitudinal axes 3, 8 are not coaxial and during the transmission of a torque acting in a circumferential direction 18 during the intended operation of the tripod joint 1, a force between the journal 10 and the inner ring 16 (or between each journal 10 and each inner ring 16) can be transmitted continuously via two contact points 19, 20.

The contact points 19, 20 move along the inner circumferential surface 26 of the inner ring 16 and along the outer circumferential surface 25 of the journal 10, respectively, when the deflection changes and as a function of the angle of rotation of the tripod joint 1. The contact points 19, 20 are thus not arranged at a fixed point in the cross-section 21, but rather move along the radial direction 11 (in the cross-section 21 under consideration) as a function of the deflection angle 32 and the angle of rotation.

In FIGS. 7 to 9, at least in the coaxial arrangement of the longitudinal axes 3, 8, the two contact points 19, 20 are arranged along the radial direction 11 at an equal distance 22, 23 from a PCR1 24 of the inner joint part 7.

In FIG. 7, in cross-section 21, a contour of an outer circumferential surface 25 of the journal 10 is convexly spherical at least between the contact points 19, 20 (or in the area of the contact points 19, 20).

In the cross-section 21, a contour of an inner circumferential surface 26 of the inner ring 16 is designed in a Gothic shape at least between the contact points 19, 20 (or in the area of the contact points 19, 20).

In cross-section 21, a contour of a surface 27 of the recess 6 that can be contacted by the outer ring 14 when the tripod joint 1 is operated as intended is designed in a Gothic shape.

In cross-section 21, a contour of a surface of the outer ring 14 that contacts the surface of the recess 6 is designed in a spherical shape.

At least in the coaxial arrangement of the longitudinal axes 3, 8, a PCR1 24 of the inner joint part 7 and a PCR2 28 of the outer joint part 2 are of equal size.

Furthermore, a retaining ring 30 is indicated in FIG. 7, which limits the mounting space 29 for the bearing bodies 17.

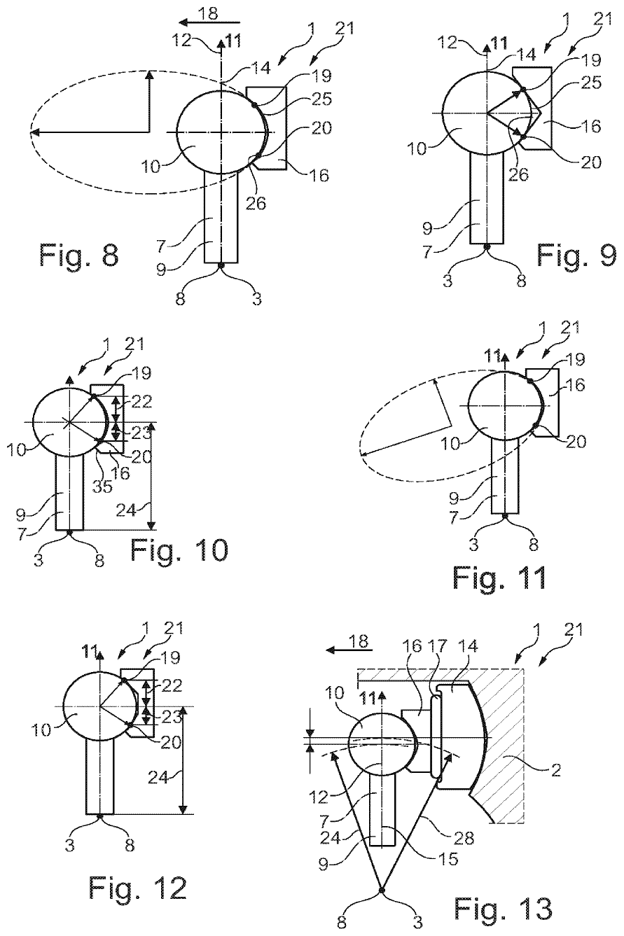

FIG. 8 shows the detail according to FIG. 6 for a second design variant of a tripod joint 1. Reference is made to the explanations relating to FIGS. 1 to 7.

In contrast to the first design variant, in the cross-section 21 a contour of an inner circumferential surface 26 of the inner ring 16 is elliptical at least between the contact points 19, 20 (or in the area of the contact points 19, 20), the major axes of this ellipse being designed tangential to the PCR1 24 and parallel to the rotational axis 15, at least when the longitudinal axes 3, 8 are arranged coaxially.

FIG. 9 shows the detail according to FIG. 6 for a third design variant of a tripod joint 1. Reference is made to the explanations relating to FIG. 8.

In contrast to the second design variant, in the cross-section 21, a contour of an inner circumferential surface 26 of the inner ring 16 is formed by two straight lines at least between the contact points 19, 20 (or in the area of the contact points 19, 20).

FIG. 10 shows the detail according to FIG. 6 for a fourth design variant of a tripod joint 1. Reference is made to the explanations relating to FIGS. 6 to 9.

In contrast to the first, second and third design variants, at least in the coaxial arrangement of the longitudinal axes 3, 8, the two contact points 19, 20 are arranged along the radial direction 11 at a different distance 22, 23 from a PCR1 24 of the inner part 7 of the joint. In this case, the second distance 23 of the second contact point 20 from the PCR1 24 is smaller than the first distance 22 of the first contact point 19 from the PCR1 24. This also applies to the fifth embodiment according to FIG. 11 and the sixth embodiment according to FIG. 12.

In the fourth embodiment according to FIG. 10, in the cross-section 21, a contour of an outer circumferential surface 25 of the journal 10 is of convex spherical design at least between the contact points 19, 20 (or in the region of the contact points 19, 20).

In the cross-section 21, a contour of an inner circumferential surface 26 of the inner ring 16 is designed in a Gothic shape at least between the contact points 19, 20 (or in the area of the contact points 19, 20).

FIG. 11 shows the detail according to FIG. 6 for a fifth design variant of a tripod joint 1. Reference is made to the explanations relating to FIG. 10.

In contrast to the fourth design variant, in the cross-section 21 a contour of an inner circumferential surface 26 of the inner ring 16 is elliptical at least between the contact points 19, 20 (or in the area of the contact points 19, 20), the main axes of this ellipse being designed at least with the longitudinal axes 3, 8 arranged coaxially, inclined to the PCR1 24 and inclined to the axis of rotation 15.

FIG. 12 shows the detail according to FIG. 6 for a sixth design variant of a tripod joint 1. Reference is made to the explanations relating to FIG. 11.

In contrast to the fifth embodiment, in cross-section 21, a contour of an inner circumferential surface 26 of the inner ring 16 is formed by three straight lines at least between the contact points 19, 20 (or in the area of the contact points 19, 20).

FIG. 13 shows the detail according to FIG. 6 for a seventh design variant of a tripod joint 1. Reference is made to the explanations relating to FIG. 7.

In the seventh design variant according to FIG. 13, in cross-section 21, a contour of an outer circumferential surface 25 of the journal 10 is designed to be convexly spherical at least between the contact points 19, 20 (or in the area of the contact points 19, 20).

In the cross-section 21, a contour of an inner circumferential surface 26 of the inner ring 16 is designed in a Gothic shape at least between the contact points 19, 20 (or in the area of the contact points 19, 20).

To achieve particularly favorable guiding properties, an offset can be provided between the first pitch radii (PCR1 24) of the outer circumferential surfaces 25 of the journals 10 (i.e. of the inner joint part 7) and the second pitch radii (PCR2 28) of the recesses 6 (i.e. of the outer joint part 2).

In contrast to the aforementioned design variants, at least in the coaxial arrangement of the longitudinal axes 3, 8, the PCR1 24 of the inner joint part 7 and the PCR2 28 of the outer joint part 2 are of different sizes, with a PCR1 24 of the inner joint part 7 being smaller than a PCR2 28 of the outer joint part 2.

1. A tripod joint comprising an outer joint part having a first longitudinal axis and a cavity extending parallel to the first longitudinal axis and having an open end, three recesses extending parallel to the first longitudinal axis being formed in the outer joint part, and an inner joint part having a second longitudinal axis, comprising at least one central body on which three journals are formed, having journal axes extending outwards from the second longitudinal axis along a radial direction, wherein on the journals is arranged in each case a roller body which has at least an outer ring and an inner ring rotatable relative to the latter about a common axis of rotation, and bearing bodies arranged between the outer ring and the inner ring; wherein in the recesses the roller bodies are movably arranged along the first longitudinal axis in each case; wherein, at least when the longitudinal axes are coaxial and when a torque acting in a circumferential direction is transmitted during intended operation of the tripod joint, a force between the journal and the inner ring can be transmitted continuously via two contact points, the contact points, in a cross-section of the tripod joint -running transversely to the longitudinal axes, being arranged at a distance from one another along the radial direction.

2. The tripod joint according to claim 1, wherein at least in the coaxial arrangement of the longitudinal axes the two contact points are arranged along the radial direction at a respectively equal distance from a PCR1 of the inner joint part.

3. The tripod joint according to claim 1, wherein, at least in the coaxial arrangement of the longitudinal axes, the two contact points are arranged along the radial direction at a different distance from a PCR1 of the joint inner part.

4. The tripod joint according to claim 1, wherein in the cross-section a contour of an outer circumferential surface of the journal is of spherical design at least between the contact points.

5. The tripod joint according to claim 1, wherein in the cross-section a contour of an inner circumferential surface of the inner ring is formed at least between the contact points in a Gothic, elliptical or at least straight line shape.

6. The tripod joint according to claim 1, wherein in the cross-section a contour of a surface of the recess, that can be contacted by the outer ring in an intended operation of the tripod joint, is spherical.

7. The tripod joint according to claim 1, wherein at least in the coaxial arrangement of the longitudinal axes a PCR1 of the inner joint part is greater than or less than a PCR2 of the outer joint part.

8. The tripod joint according to claim 1, wherein one of the inner ring and outer ring together with the bearing bodies is displaceable along the axis of rotation relative to the other of the inner ring and outer ring.

9. The tripod joint according to claim 1, wherein a mounting space for the bearing bodies on the outer ring or on the inner ring is limited by a retaining ring arranged on the respective ring.

10. A motor vehicle comprising at least one tripod joint according to claim 1.
